(19) United States
(12) Patent Application Publication
(10) Pub. No.: US 2005/0139268 A1
(43) Pub. Date: Jun. 30, 2005

(54) Tap with position indicator

(76) Inventors: Paul Kremer, Walferdange (LU); Jacques Schmit, Eppeldorf (LU)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/001,107

(22) Filed: Dec. 1, 2004

(30) Foreign Application Priority Data
Dec. 24, 2003 (EP) 03079185.9

(51) Int. Cl. F16K 37/00

(52) U.S. Cl. 137/553

(57) ABSTRACT

A tap for a gas cylinder is provided with a position indicator comprising a cylindrical skirt disposed about a cylindrical support member. The skirt is coupled to an actuating wheel of the tap for rotation therewith and for displacement axially with respect to the actuating wheel along the longitudinal axis of the tap. The support member is mounted on the tap body and, in normal operation of the tap, it is retained in fixed position with respect to the tap body. The skirt has an internal screw thread engaging an externally threaded portion of the support member. In closed position of the tap the skirt masks a signaling portion of the support member. When the actuating wheel is rotated to open the tap the skirt is displaced in a direction to uncover the signaling portion to indicate the open position of the tap. The signaling portion may be colored, for example in red.

### CROSS-REFERENCE TO RELATED APPLICATIONS

This application claims priority to European Patent Application No. 03079185.9 filed Dec. 24, 2003, and which is incorporated herein by reference.

### STATEMENT REGARDING FEDERALLY SPONSORED RESEARCH OR DEVELOPMENT

Not Applicable.

### BACKGROUND OF THE INVENTION

The present invention relates to a tap, especially a tap for a gas or liquefied gas cylinder, comprising a fixed tap structure including a tap body, an actuating wheel rotatable about an axis of rotation with respect to the fixed tap structure to open or close the tap, and a means for indicating the open or closed position of the tap, said means comprising a movable element for covering or exposing a signaling means, said signaling means indicating by its visibility or invisibility the open or closed condition of the tap.

Taps provided with a means or a device permitting an operator to see the closed or open condition of the tap on the exterior thereof are known in the state of the art. For example, in a known prior art tap a fixed ring or band is provided on the exterior surface of the tap body. This ring is normally masked by the actuating wheel of the tap and it has color different from the tap body and the actuating wheel. This simple system functions only with a tap having an upwardly and downwardly movable actuating wheel and stem assembly in view of the fact that the ring can only be uncovered or exposed by actuating wheel movement in axial direction relative to the tap body. Further, for a tap of very small opening movement, the actuating wheel moves only a very limited axial distance relative to the tap body and the ring indicating the open position of the tap would be only very slightly uncovered and therefore not be clearly discernible below the actuating wheel.

Known in the art are also taps having actuating wheels provided with windows through which marks can be seen on fixed tap structure indicating the open or closed position of the tap. However, these devices are limited to taps whose actuating wheel is only movable a fraction of a turn, such as a quarter turn, for opening and closing the tap.

Finally, in the prior art taps are known having relatively complex and cumbersome systems for indicating the open or closed condition of the tap.

### BRIEF SUMMARY OF THE INVENTION

The object of the present invention is to avoid these disadvantages and to provide a tap having a simple means or device for indicating the open or closed condition of the tap, which is easily visible on the exterior of the tap, and which can be used on a tap having an upwardly and downwardly movable stem, on a tap having a rotating stem (not movable upwardly and downwardly) and also on a tap having an actuating wheel rotatable only a fraction of a turn or multiple turns for opening or closing the tap.

According to the invention the movable element of the indicating means is a skirt coupled, on one side, to the actuating wheel so as to be entrained in rotation therewith and coupled, on another side, to the fixed tap structure by a means causing, under the effect of rotational movement of the skirt in one or the other direction, an axial displacement thereof along the axis of rotation with respect to the actuating wheel and with respect to the fixed tap structure so as to cover or expose the signaling means.

Accordingly, the movable skirt of the means for indicating the open or closed position of the tap effects an upward or downward movement relative to the fixed tap structure in response to the rotational movement of the actuating wheel of the tap to uncover or cover the signaling means even if the actuating wheel or the tap stem does not move upwardly or downwardly. The coupling between the movable skirt and the fixed tap structure can be designed by selection of an appropriate angle of inclination or pitch angle of the engagement means between these two parts so as to produce a sufficient axial movement of the skirt to uncover or expose a large signaling surface of substantial height or width so as to be easily visible or discernible on the exterior of the tap. Similarly, for taps having a stem without axial movement or small axial movement and also for taps having a quarter turn actuating wheel for opening or closing the tap, a large signaling surface having a substantial height can be exposed.

According to a preferred embodiment of the invention the device or means for indicating the open or closed condition of the tap comprises an annular support member separate from the tap body (but being a part of the fixed tap structure) and mounted normally stationary with respect thereto, and the movable skirt surrounds the annular support member and is provided with an internal single or multiple threaded screw thread engaged with a correspondingly internally threaded portion of the support member. In this embodiment the signaling means is provided on the annular support member on a lower portion thereof to be exposed by the axial movement of the skirt when the actuating wheel of the tap is rotated in a direction to open the tap. At least the lower portion of the annular support member provided with the signaling means (or forming the signaling means) or the entirety of this member may be distinguished from the adjacent surfaces of the tap body and the actuating wheel by at least one of the conditions comprising a different surface finish, a different color, and a different material.

The annular support member is fixed to the tap body by a friction fit, namely a press fit, and it is moreover provided with a central polygonal or star-shaped opening having for example 24 angles or facets arranged in zigzag or in accordion-type fashion, engaged on an end portion of polygonal shape, for example square- or hexagonal shape, of a gland ring of the tap. The annular support member may have one or more rupture initiation areas to permit opening or closing of the tap in case of jamming of the skirt between the actuating wheel and the annular support member, by application of a sufficient force to the actuating wheel causing breakage of the support member at the rupture initiation areas. In addition, the retention force of the press fit engagement of the annular support member on the tap body and the design of the polygonal shape of the opening in the support member can be selected to permit the support member to be rotated about the tap body and the gland ring by application of a sufficient force to the actuating wheel to overcome the retention force of the press fit and deform the polygonal opening in case the support member is fabricated from a high strength material tending to resist breakage at the rupture initiation areas.

To couple the movable skirt to the actuating wheel for rotating therewith it is provided at its upper extremity with a flange provided with a plurality of projection portions or lobes spaced from one another in circumferential direction and received in recesses of corresponding shape formed in the interior of a cavity of the actuating wheel. The lower extremity of the skirt is visible below the actuating wheel at least in the position thereof covering the indicating means.

Preferably, in the tap closed position the movable skirt is in a lower position covering the lower extremity of the annular support member or the signaling means provided at its lower extremity or adjacent thereto and by rotational movement of the actuating wheel in a direction to open the tap the movable skirt is caused to be displaced axially upwardly to thereby uncover the lower end portion or extremity of the annular support member or its signaling means for indicating the condition of the tap so as to be easily visible, even from a remote location, on the exterior of the tap to thereby indicate the open position of the tap.

### BRIEF DESCRIPTION OF THE SEVERAL VIEWS OF THE DRAWINGS

FIG. 1 is a vertical sectional view of a rotating stem tap (stem without upward and downward movement) having a device according to the invention for indicating the open or closed condition of the tap;

FIGS. 2A and 2B show a tap having an upwardly and downwardly movable stem and actuating wheel provided with a device according to the invention for indicating the open position (FIG. 2A) or the closed position (FIG. 2B) of the tap;

FIGS. 3A, 3B and 3C show the movable skirt and the annular support member constituting the device for indicating the open and closed condition of the tap, FIG. 3A showing the position of the elements of the indicating device in the closed condition of the tap, FIG. 3B showing the position of the elements of the indicating device in the open condition of the tap, and FIG. 3C showing the position of the elements of the indicating device in perspective view in open condition of the tap;

FIGS. 4A and 4B show the movable skirt of the indicating device in vertical section (FIG. 4A taken along line A-A of FIG. 4B) and in bottom view (FIG. 4B), respectively; and

FIGS. 5A and 5B show the annular support member of the device for indicating the open or closed position of the tap, FIG. 5B being a view in vertical section taken along line A-A of FIG. 5A and FIG. 5A being a bottom view of FIG. 5B.

Corresponding reference numerals will be used throughout the several figures of the drawings.

### DETAILED DESCRIPTION OF THE INVENTION

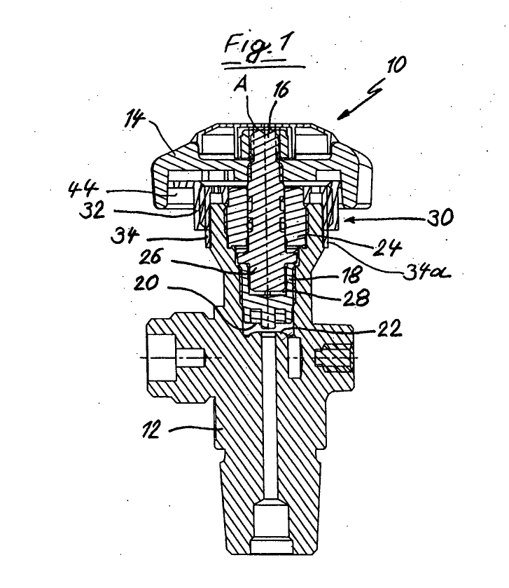

The tap according to the invention will now be described in greater detail. As shown in FIG. 1, the tap 10 includes a fixed tap structure having a tap body 12. An actuating wheel or hand wheel 14 is coupled to a stem 16 which is in turn coupled to a movable seat element 18 carrying a sealing member 20 engaging a fixed seat 22 of the tap body 12 in the closed position of the tap 10. The stem 16 is mounted for rotation in a gland ring 24 threaded into a threaded portion of the tap body 12 at the upper end thereof. The stem 16 is provided at its lower end with a square-shaped portion 26 engaged in a square-shaped cavity 28 of the movable seat element 18. The movable seat element 18 is threaded into a threaded portion within the interior of the tap body 12. The tap 10 is accordingly of the rotating stem type, namely the stem 16 and the actuating wheel 14 do not move vertically or axially for opening or closing the tap. Only the movable seat element 18 effects a vertical or axial movement when the stem 16 is rotated in the opening or closing direction of the tap 10.

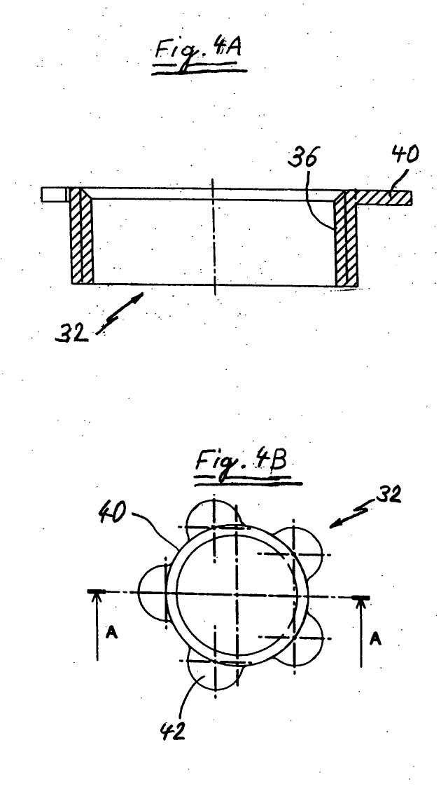

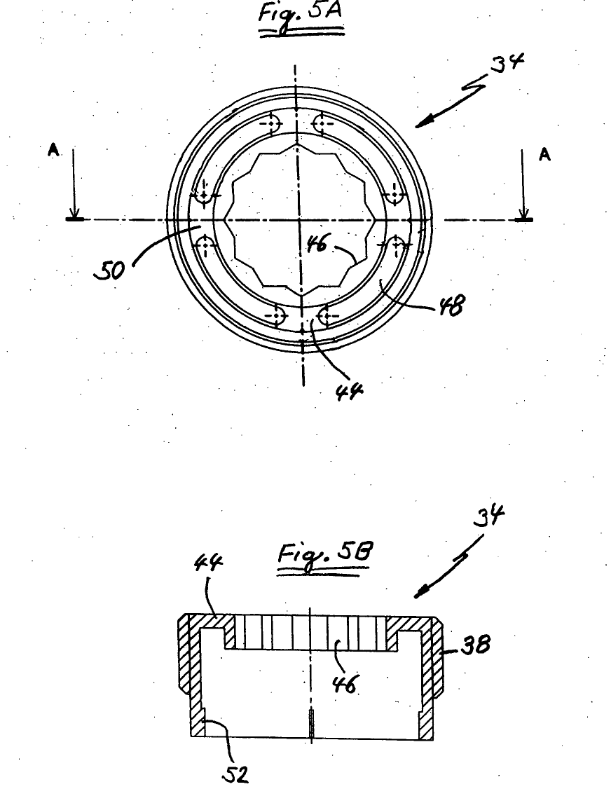

Referring further to FIG. 1, the mechanism for indicating the open or closed position of the tap, designated in its entirety by 30, comprises an external cylindrical movable skirt 32 and an internal cylindrical annular support member 34 fixed to the tap body 12. The movable skirt 32 is coupled to the actuating wheel 14 so as to be driven in rotation by the rotating wheel 14 while permitting an axial movement of the skirt 32 along the longitudinal axis A of the tap 10 relative to the annular support member 34 and also relative to the fixed tap structure including body 12 and support member 34. The skirt 32 surrounds the annular support member 34 and the upper portion of the skirt 32 is received within the interior of the actuating wheel 14 while its lower portion is exposed and located exteriorly of the actuating wheel 14 below the same. The support member 34 is fixedly mounted by a pressed friction fit on the tap body 12 so as to normally prevent displacement or rotation of the support member 34 with respect to the tap body 12. The annular support member 34 is also extended axially downwardly beyond the lower end of the actuating wheel 14. The skirt 32 is provided with an internal screw thread 36, see FIG. 4A, and this thread is in engagement with an externally threaded portion 38 of the internal support member 34, note FIG. 5B.

As best shown in FIG. 4B the movable skirt 32 is provided at its upper end with a flange 40 having a plurality of projections, or lobes 42 of generally semi-circular shape extending outwardly and spaced from one another in circumferential direction of the skirt 32. The projections 42 are received in recesses, for example 44, of corresponding shape, see FIG. 1, formed in the internal circumferential surface of a downwardly open cavity defined within the actuating wheel 14. The skirt 32 is accordingly coupled to the actuating wheel 14 for rotation therewith and cannot move in rotational direction with respect to the actuating wheel 14. During rotational movement of the actuating wheel 14 and the skirt 32 about the annular support member 34 and the tap body 12, the projections 42 of the skirt 32 move vertically within the recesses 44 of the actuating wheel 14. Any other means can be provided for coupling the movable skirt 32 to the actuating wheel 14 for rotation therewith, for example axial pins (not shown) fixed to the actuating wheel 14 and received in axial holes (not shown) formed in the movable skirt 32.

The FIGS. 5A and 5B show the internal annular support member 34 which is normally stationary or fixed with respect to the tap body 12. The annular support member 34 is provided at its upper end with a radial annular wall 44 provided in the center thereof with a polygonal opening 46, preferably a star-shaped opening having 24 facets disposed in zigzag or of accordion-type fashion, or having 24 angles opening alternately inwardly and outwardly. In addition the radial annular wall 44 is provided with a plurality of elongated curved apertures 48 spaced from one another in circumferential direction and leaving predetermined rupture areas 50 between adjacent apertures 48. The annular support member 34 is provided at the lower end of its internal cylindrical surface with a plurality of vertical ribs 52 frictionally engaging the external surface of the tap body 12 when the annular support member 34 is press fitted onto the tap body 12. When the annular support member 34 is mounted on the tap body 12, the polygonal opening 46 engages the polygonal, square-shaped or hexagonal end portion of the gland ring 24, as shown in FIG. 1, to prevent rotation of the support member 34 about the tap body 12 and the gland ring 24.

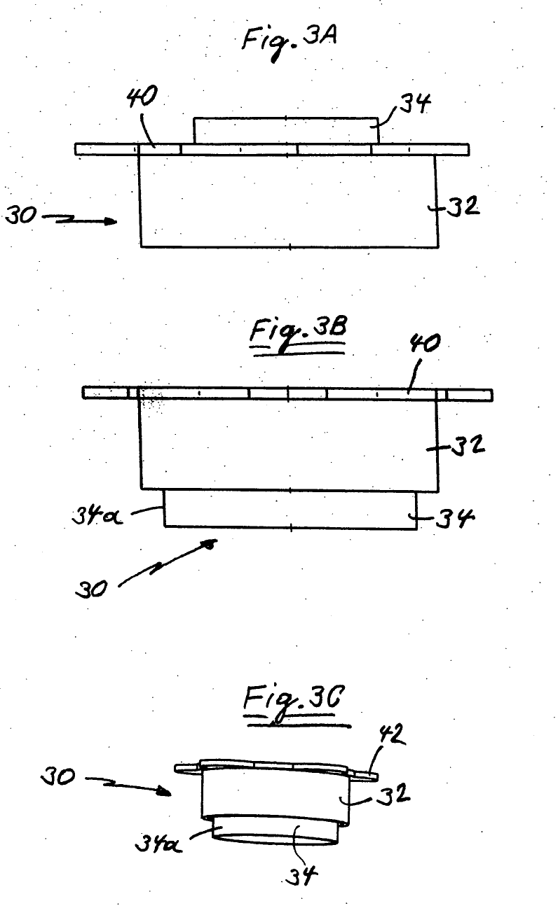

The FIGS. 3A, 3B and 3C show the assembled annular elements or internal and external rings 32, 34 (namely the skirt 32 and the support member 34) of the indicating device. In the position of FIG. 3A the skirt 32 masks or covers the lower extremity of the support member 34. In this position of the two elements 32 and 34 the tap is in the closed position. In the FIGS. 3B and 3C the movable skirt 32 is displaced upwardly and the lower portion 34a of the internal support member 34 is visible below the lower extremity of the external skirt 32. This position is also shown in FIG. 1 and represents the open condition of the tap 10. The lower portion 34a of the support member 34 serves accordingly as signaling surface or portion for indicating the position of the tap and indicates the open position thereof when it is visible below the movable skirt 32. Preferably, the two members 32 and 34 are fabricated from plastic material and at least the lower portion of the support member 34 has a different color than the movable skirt 32 and the tap body 12, for example a red color. The signaling surface of the support member 34 may be formed by a colored band applied to member 34 or an annular painted area thereof. It is also possible to fabricate the element 34 from a different material than element 32 and tap body 12 and/or to provide for example a bright appearance or other surface finish for the lower extremity 34a of the support member 34, particularly if the two elements 32 and 34 are metallic. The signaling surface may alternatively also be provided on the tap body 12 and may be a colored surface portion thereof or a colored band fixed thereto.

It will be understood that during rotation of the actuating wheel 14 the movable skirt 32 will rotate with the wheel 14 and due to the threaded engagement between the elements 32 and 34, the external element or skirt 32 will move vertically while the internal element 34 remains stationary. The pitch angle of the threaded engagement between the two elements 32 and 34 is selected to be sufficiently high so as to uncover a substantial portion of the support member 34 at the lower extremity 34a thereof. An axial motion or substantial axial motion of the actuating wheel 14 is not necessary for exposing the lower portion 34a of the support member 34. If the axial displacement of the actuating wheel is small or if its rotation is only a fraction of a turn, such as a quarter turn, the pitch angle of the threaded portions 36 and 38 is selected sufficiently high to ensure uncovering of a substantial portion of the lower extremity 34a of the support member 34. It is also possible to provide multiple threaded screw threads to increase the axial displacement of the skirt 32.

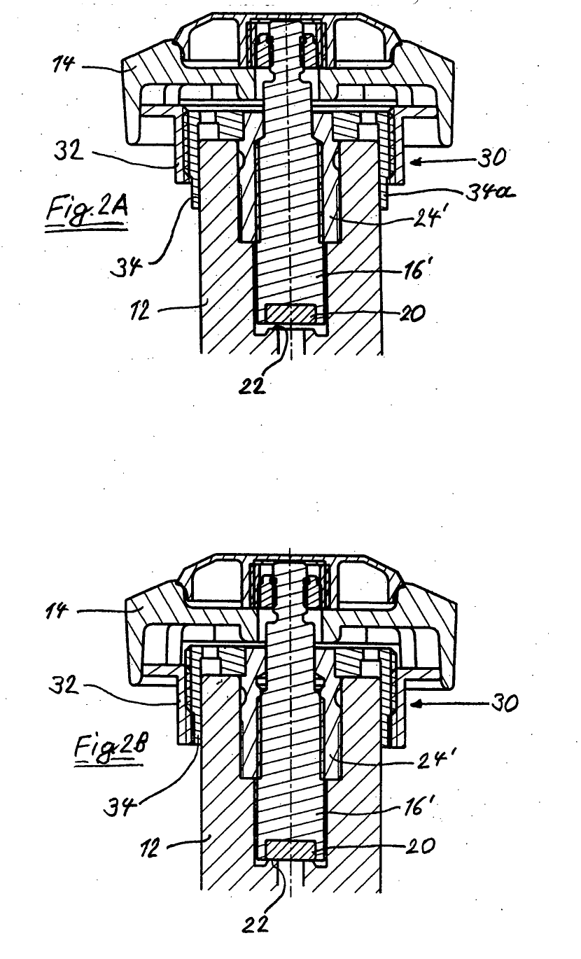

As mentioned hereinbefore, the indicating device according to the invention can also be used in combination with a tap having an upwardly and downwardly movable stem, namely a tap provided with an actuating wheel that moves axially with respect to the body when the wheel is rotated for opening or closing the tap. Such a tap is shown schematically in FIGS. 2A and 2B, the FIG. 2A showing the open position and the FIG. 2B the closed position of the tap. The indicating device 30 comprising the skirt 32 and the annular support member 34 is the same as in the embodiment of FIGS. 1, 3A, 3B, 3C, 4B, 4B and 5A, 5B and does not need to be described here again in detail.

During the lifetime of the tap the skirt 32 may possibly get stuck between the internal support member 34 and the actuating wheel 14. In this case the tap may be opened or closed by exertion of a larger actuation force on the actuating wheel 14 causing breakage of the predetermined rupture areas 50 of the annular support member 34. If the support member 34 is fabricated from a strong material tending to resist breakage of the predetermined rupture areas 50 the larger force applied to the actuating wheel 14 may cause rotation of the support member 34 about the tap body 12 and about the polygonal end portion of the gland ring 34 by deformation of the polygonal opening 46 of the annular support member 34. Of course, this force must also overcome the retention force of the press-fitted engagement of the annular support member 34 on the tap body 12. The frictional engagement is accordingly a relatively weak frictional engagement but which is sufficient to normally retain the annular support member 34 against rotation in combination with the engagement of the polygonal opening 46 on the polygonal end portion of the gland ring 24.

It is to be understood that instead of the threaded portions 36 and 38 of the external and internal elements 32 and 34 it is also possible to provide any other means causing a vertical or axial movement of the external element 32 with respect to the internal element 34 when the external element 32 is rotated about the axis A of the tap 10.

For example, instead of the threaded portions 36 and 38 the external portion 32 may also be provided with pins (not shown) spaced circumferentially from one another and extending inwardly from the internal cylindrical surface of the skirt 32 to be received in helical grooves (not shown) of the internal element 34. Alternatively, the pins may be provided on the internal support element 34 and received in helical grooves of the skirt 32.

In another embodiment, the internal element or the support member 34 may be eliminated and the movable skirt 32 may be mounted directly on the tap body 12 and coupled thereto by any appropriate means, such as a threaded engagement, for causing vertical or axial displacement of the skirt 32 when it is rotated by means of the actuating wheel 14 about the axis A of the tap 10. In this case a portion of the body 12 of the tap 10 to be uncovered or masked by the skirt 32 serves as the signaling means or the signaling surface to indicate the position of the tap 10. This portion of the tap body 12 may be colored, for example in red, or may have another surface finish, for example a bright appearance to distinguish it from the adjacent surfaces of the tap 10 and the skirt 32, or may be provided with a colored band or other means, applied to the external surface of the tap body 12.

Further, by an appropriate design of the means causing the external element 32 to move vertically when rotated by means of the actuating wheel 14, for example by an appropriate form of the threaded portions 36 and 38, such as a right hand thread or a left hand thread, the device for indicating the position of the tap 10 may be formed to mask the indicating portion of the tap body 12 or of the member 34 in the closed position of the tap and to expose the indicating portion in the open position of the tap, as described hereinbefore, or contrarily, namely to mask the indicating portion in the open position and to expose it in the closed position of the tap.

From the preceding description it will be understood that the mechanism of the invention permits one to see the open or closed position of the tap 10 on the exterior thereof even when the stem 16 and the actuating wheel 14 do not move vertically or axially along the axis A for opening or closing the tap 10. The same functioning is also insured for a tap whose actuating stem 16′ is threaded into the gland ring 24′ or into the tap body and carries the sealing member 20 adapted to tightly engage the tap seat 22 (FIGS. 2A and 2B). If in a tap of this type the pitch of the screw thread between the stem 16′ and gland ring 24′ or the tap body is small for a small opening movement, a signaling surface 34a or an indicating portion of substantial height may nevertheless be exposed by providing a larger pitch angle for the engaged threaded portions of the external element 32 and the internal element 34 than for the threaded engagement of the stem 16′ in the gland ring 24′ or in the tap body 12.

Finally, the signaling portion or surface 34a of the internal element 34 does not need to extend down to the lower extremity of the element 34, but the internal element 34 may be provided at its lower extremity with a small circumferential external stop (not shown) on which the external portion 32 comes to seat in closed or open position of the tap, so as to mask the signaling portion or surface 34a provided above the circumferential stop. Also, the external element 32 may have one or a plurality of windows (not shown) spaced circumferentially and/or axially from one another and adapted to be aligned with one or more signaling surfaces (not shown) arranged in a similar manner on the internal element 34 or on the tap body 12.

A spring (not shown) may be provided between the actuating wheel 14 and the support member 34 to eliminate any backlash between these elements and to serve to safely retain the parts in position.

According to a still further embodiment, the skirt can be totally retractable into the interior of the actuating wheel in one of the two positions (open or closed) of the tap and extended partly from the interior of the wheel in the other position of the tap. In this case the signaling means may be provided on the tap body or may be provided on the portion of the skirt to be extended from within the actuating wheel in one of the two positions of the tap.

Other variations or modifications may be made by the skilled person to the preferred embodiments described hereinbefore and shown in the drawings without leaving the scope of the invention as defined by the annexed claims.

1. A tap, especially for a gas or liquefied gas cylinder, comprising a fixed tap structure including a tap body, an actuating wheel rotatable about an axis of rotation with respect to the fixed structure to open or close the tap, and a means for indicating the open or closed position of the tap, said means comprising a movable element for covering or exposing a signaling means, said signaling means indicating by its visibility or invisibility the open or closed condition of the tap, said movable element of the indicating means being a skirt coupled, at one side, to the actuating wheel in order to be entrained in rotation therewith and coupled, on another side, to the fixed tap structure by means causing, under the effect of the rotational movement of the skirt in one or the other direction, an axial displacement of the skirt along the axis of rotation with respect to the actuating wheel and with respect to the fixed tap structure to cover or expose the signaling means.

2. The tap according to claim 1, wherein the indicating means comprises an annular support member, said support member being a part of said fixed tap structure and being normally retained in a fixed position against rotational movement with respect to the tap body, said skirt being coupled to said annular support member so as to cause axial displacement of the skirt in response to rotational movement thereof relative to said annular support member.

3. The tap according to claim 2, wherein the means causing an axial displacement of the skirt under the effect of its rotational movement is selected between the following alternatives:
a. a threaded portion having at least one screw thread formed on the internal surface of the skirt and being in engagement with a corresponding threaded portion formed on the external surface of the annular support member,
b. at least one helical groove formed in one of the elements comprising the skirt and the annular support member and at least one pin engaged into said at least one groove and provided on the other of the elements comprising the skirt and the annular support member.

4. The tap according to claim 2, wherein the signaling means is on a portion of the annular support member, said signaling means portion of the support member being covered by the skirt when the tap is closed or open and being exposed on the exterior of the tap by axial displacement of the skirt with respect to the annular support member in response to rotational movement of the actuating wheel for opening or closing the tap.

5. The tap according to claim 4, wherein at least said signaling means portion of the annular support member is distinguished from the remaining portion of the skirt and other adjacent surfaces of the tap by at least one of the flowing conditions:
a. a different surface finish
b. a different color
c. a different material

6. The tap according to claim 4, wherein the signaling means is a colored band applied to the annular support member.

7. The tap according to claim 2, wherein the signaling means is on the tap body, said signaling means being covered by the skirt when the tap is closed or open and exposed on the exterior of the tap by axial displacement of the skirt with respect to the annular support member in response to rotational movement of the actuating wheel for opening or closing the tap.

8. The tap according to claim 7, wherein the signaling means is distinguished from adjacent surfaces of the tap by at least one of the following conditions:
a. a different surface finish
b. a different color
c. a different material.

9. The tap according to claim 7, wherein the signaling means is a colored band applied to the tap body.

10. The tap according to claim 4, wherein said portion of the annular support member is an annular portion of the support member provided at, or in proximity of, the extremity of the annular support member spaced from the actuating wheel of the tap.

11. The tap according to claim 2, wherein the annular support member is mounted by a press-fitted engagement on the tap body so as to be normally retained against rotation by frictional engagement with the tap body.

12. The tap according to claim 11, wherein the annular support member comprises ribs on its internal surface for frictionally engaging the tap body.

13. The tap according to claim 2, wherein the annular support member is provided with a central opening of polygonal shape engaging a polygonal end portion of a gland ring of the tap to normally prevent rotational movement of the annular support member with the skirt and the actuating wheel.

14. The tap according to claim 13, wherein the polygonal shape of the opening of the annular support member is formed to permit rotation thereof with the skirt about the gland ring and about the tap body by exertion of a sufficient rotational force on the actuating wheel to cause deformation of the polygonal shape of the opening of the annular support member and permit rotation thereof about the gland ring in case the skirt becomes stuck between the annular support member and the actuating wheel.

15. The tap according to claim 2, wherein the annular support member is provided with at least one predetermined rupture area so as to permit opening or closing of the tap by exerting a sufficient rotational force on the actuating wheel causing breakage of the predetermined rupture area.

16. The tap according to claim 1, wherein the movable skirt is provided with a flange having a plurality of radial projections spaced one from the other in circumferential direction of the flange, said projections being received in recesses of corresponding shape formed in an internal surface of the actuating wheel so as to couple the movable skirt to the wheel for rotation therewith.

17. The tap according to claim 1, wherein the skirt masks the signaling means in the closed position of the tap and is axially spaced therefrom to expose it in the open position of the tap.

18. The tap according to claim 2, wherein the skirt and the annular support member are fabricated from plastic material.

19. The tap according to claim 1, wherein the movable skirt is directly coupled to the tap body and the means for causing an axial displacement of the skirt under the effect of its movement of rotation is selected among the following alternatives:
a. a threaded portion having at least one screw thread formed on the internal surface of the skirt and being in engagement with a corresponding threaded portion formed on the external surface of the tap body,
b. at least one helical groove formed in one of the elements comprising the skirt and the tap body and at least one pin engaged into said at least one groove and provided on the other of the elements comprising the skirt and the tap body, and
wherein the signaling means is provided on one of the tap body and the skirt.

20. The tap according to claim 19, wherein the signaling means is on a portion of the skirt and at least the signaling means portion of the skirt is distinguished from the remaining portion of the skirt and from other adjacent surfaces of the tap by at least one of the following conditions:
a. a different surface finish
b. a different color
c. a different material.

21. The tap according to claim 19, wherein the signaling means is on the tap body and is distinguished from adjacent portions of the tap by at least one of the following conditions:
a. a different surface finish
b. a different color
c. a different material.

22. The tap according to claim 19, characterized in that the skirt is made from plastic material.

23. The tap according to claim 19, wherein the signaling means is a colored band provided on one of the tap body and the skirt.
